(19) United States
(12) Patent Application Publication
(10) Pub. No.: US 2020/0005161 A1
(43) Pub. Date: Jan. 2, 2020

(54) SPECIFICATION FORMAT FOR PREDICTIVE MODEL

(71) Applicant: SAP SE, Walldorf (DE)

(72) Inventors: Nicolas Dulian, Houilles (FR); Savaneary Sean, Bussy Saint Georges (FR)

(21) Appl. No.: 16/023,119

(22) Filed: Jun. 29, 2018

(51) Int. Cl. G06N 5/02; G06F 17/27; G06F 17/30

(52) U.S. Cl. CPC G06N 5/02; G06F 17/30598; G06F 17/2705

(57) ABSTRACT

Provided are systems and methods for generating specification of a predictive model. In one example, the method may include receiving a predictive model developed via a test environment, generating a specification for the predictive model, the specification comprising a description of the predictive model in a format that is configured to be parsed and integrated into a predictive analytics application, and storing the generated specification in memory.

### BACKGROUND

Predictive analytics can guide organizations in making informed decisions. According to predictive analytics, predictive models are “learned” based on large volumes of historical data and the models are then deployed in a production environment to predict future scenarios. The production environment may require the predictive model to be described in a particular format, such as Structured Query Language or the like.

It may be difficult to generate a learned predictive model in a format required by a production environment. Optimization of such a predictive model for the production environment presents further difficulties which may be best handled by developers of the production environment. Accordingly, what is needed is a system to efficiently describe predictive models in an agnostic and parseable manner.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a computing environment for deploying a predictive model in accordance with an example embodiment.

FIG. 2 is a diagram illustrating a process of generating a specification of a predictive model and importing the specification into an application in accordance with example embodiments.

FIGS. 3A-3D are diagrams illustrating examples of objects that may be included within a specification in accordance with example embodiments.

FIG. 4 is a diagram illustrating a method for generating a specification for a predictive model in accordance with an example embodiment.

FIG. 5 is a diagram illustrating a computing system in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a system and method for generating a specification which includes a description of a predictive formula (regression, classification, etc.) (i.e., a predictive model). The specification may be in JavaScript Object Notation (JSON) format and may include a definition of the predictive model along with transformations applied on raw data and influencers (variables of the model). The JSON format is not program code but is a description that can be parsed by a consumer system to extract the predictive formula therefrom and any other information needed, and integrated within applications written in multiple types of programming languages. By generating the specification, the example embodiments enable an application developer/consumer to integrate the predictive model in a manner that best suits the application.

The specification may be generated by a producing system in a test environment. In some embodiments, the specification may be exported to a consuming system in a production environment, which parses the specification to extract the predictive model and generates native code to implement the predictive model. The predictive model described by the specification may include equations (polynomials) having variables, data ranges, and the like. For example, the predictive model may include an encoding function to be applied on each variable of the model, and formulas to compute various predictive indicators based on the model.

A predictive model may be trained (e.g., through machine learning) using historical data as is known in the art and may be used to provide a prediction based on new/live data. Predictive models can be applied to various domains such as supply chain, weather, machine/equipment assets, maintenance, and the like. The predictive model may be trained based on patterns, trends, anomalies, and the like, identified within historical data. As a non-limiting example, a predictive model may include a sum of different variables with a coefficient. Examples of predictive model types include regression, classification, clustering, time-series, and the like.

The example embodiments include a specification that identifies transformations applied on variables, encoding information, and formulas. The specification may define all transformations steps applied on the variables until the value of the predictive indicator is reached.

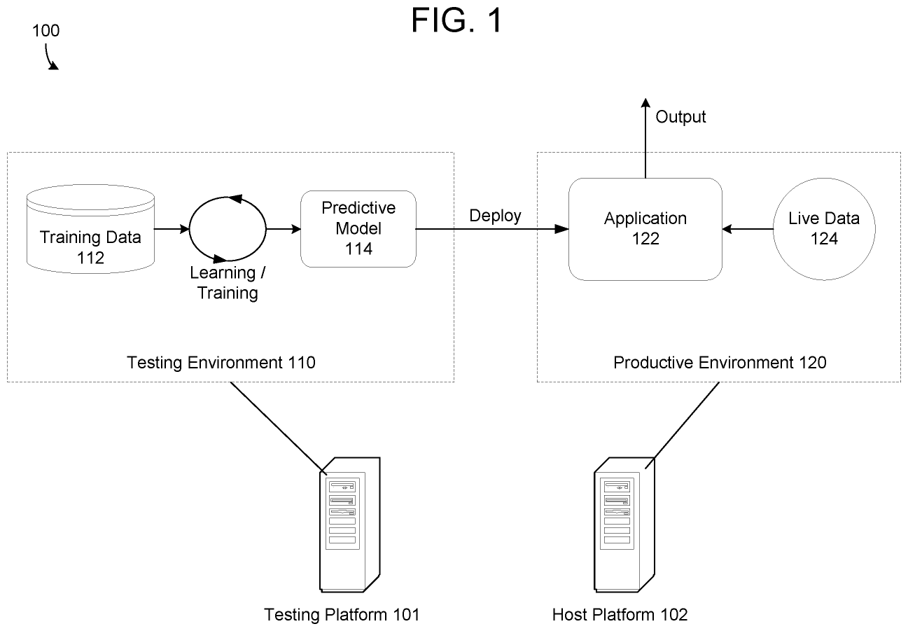

FIG. 1 illustrates a computing environment 100 for deploying a predictive model in accordance with an example embodiment. Referring to FIG. 1, the environment 100 may include multiple executing environments such as a testing environment 110 (also referred to as a development environment) and a production environment 120 (also referred to as a live environment). In this example, the testing environment 110 is operated by a testing platform 101 and the production environment 120 is operated by a host platform 102. For example, each of the testing platform 101 and/or the host platform 102 may be a server, a cloud platform, a database, a combination of devices, and the like. Although not shown in FIG. 1, in some cases, the testing environment 110 and the productive environment 120 may be operated by the same computing system or they may be operated by different devices or groups of devices.

Within the testing environment 110, users such as a data scientist may build (train) the predictive model 114 based on historical training data 112. The users may look for bugs, design defects, and the like, while evaluating a performance of the predictive model 114 through an iterative process. Meanwhile, the production environment 120 is where the model 114 may be deployed and put into operation for its intended use. For example, the predictive model 114 may be deployed from the testing environment 110 into the productive environment 120 and integrated with application 122.

In industrial use cases, the testing environment 110 where changes are originally made and the production environment 120 (what end users use) are separated through several stages in between. This structured release management process allows for phased deployment (rollout), testing, and rollback in case of problems. The phased deployment may include various stages which may include an initial hypothesis stage where a hypothesis is proposed, a load and transform data stage where data relevant to the hypothesis is collected and converted to fit a framework, a feature identification stage where data scientists can tailor a model before building it, a model building stage where one or more machine learning algorithms may be selected based on various factors (data, use case, available computational resources, etc.) and used to created predictive model 114, an evaluation stage where the predictive model 114 is evaluated with test data, and a deployment stage where the fully trained predictive model 114 is launched or otherwise deployed into the live production environment 120 where it can generate and output predictions based on live data 124.

According to various embodiments, when the predictive model 114 is deployed from the testing environment 110 into the production environment 120, one or more of the testing platform 101 and the host platform 102 may generate a specification describing the predictive model in a generic format. The specification can be parsed and integrated into the application 122 in order to deploy the predictive model 114.

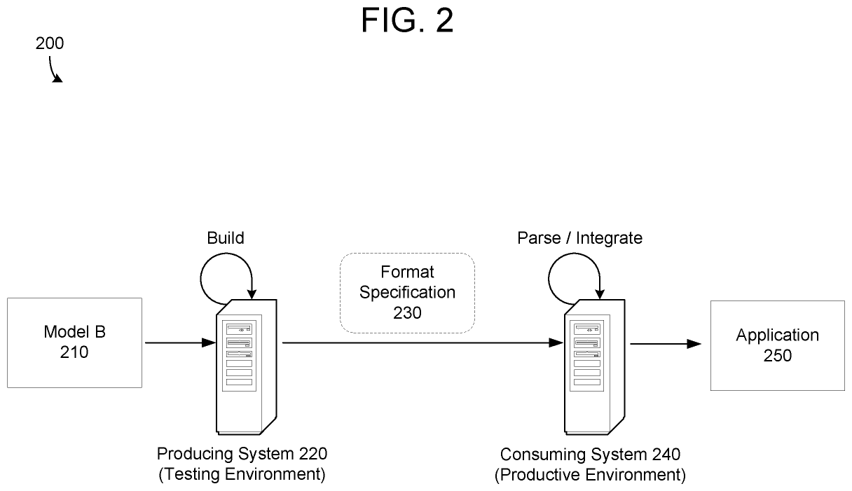

In some embodiments, a user interface enables a user to select one or more predictive models which may be deployed and integrated with an application. For example, the user interface may display or otherwise output a list of predictive models available for integration within an application. In order to integrate a predictive model into the application, a process 200 shown in FIG. 2 may be performed.

Referring to FIG. 2, a producing system 220 may generate a specification 230 based on a a predictive model 210. The specification 230 may describe all elements of the predictive model 230 (classification, regression, etc.) For example, the specification 230 may include the transformation of raw data and one or more influencers of the predictive model including encoding data. In addition to the predictive model 210, the specification 230 can also include formulas of various predictive indicators (probabilities, error bars, odds ratio, etc.) The specification 230 may be conform to a format such as a JSON format.

The format specification 230 describes the predictive model 210 in a format that can be parsed by a consuming system 240 to extract the model and freely integrate the model within an application 250. All subsequent processing applied on variables within the formulas can be defined and may include internal transformations applied on input variables to derive additional variables, encoding of the variables, computation of predicted values from the encoded variables, and the like.

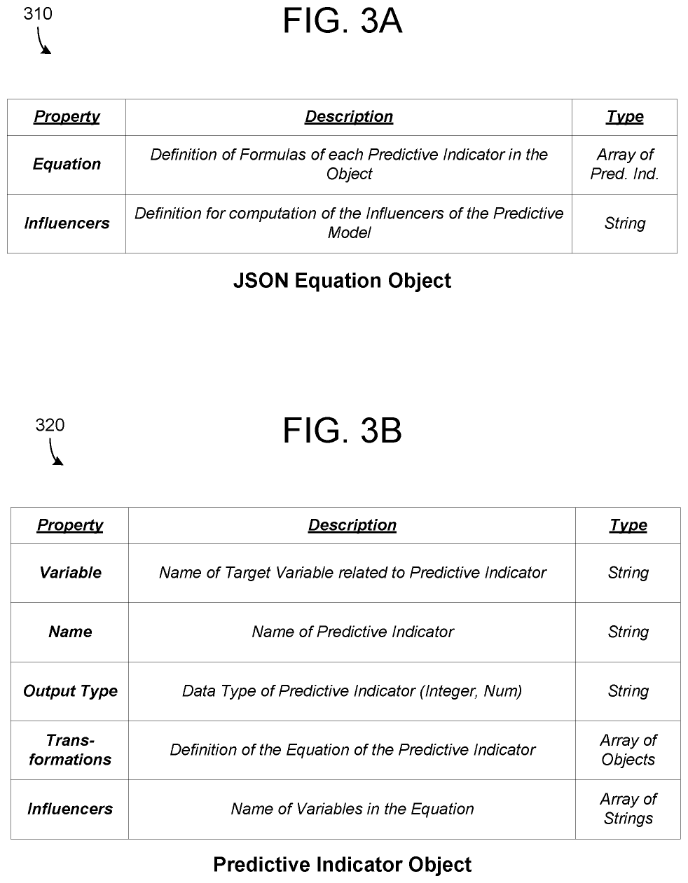

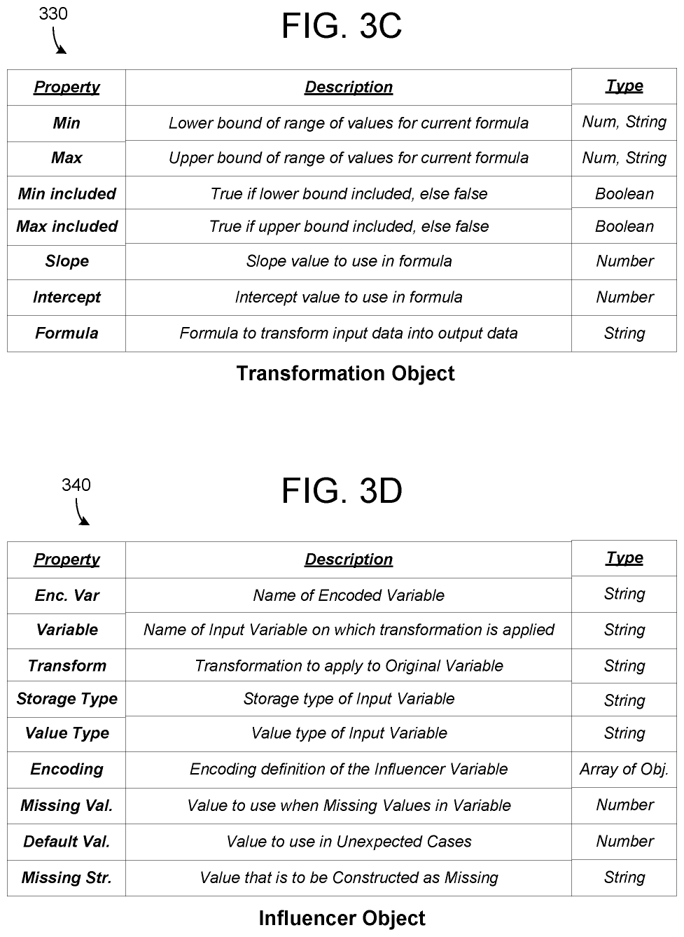

FIGS. 3A-3D illustrate examples of various objects of data which may be included within a specification, according to various example embodiments. FIG. 3A illustrates an example of an equation object 310, FIG. 3B illustrates an example of a predictive indicator object 320, FIG. 3C illustrates an example of a transformation object 330, and FIG. 3D illustrates an example of an influencer object 340. It should be appreciated that the objects shown in FIGS. 3A-3D are merely for purposes of example and are not meant to limit the types and amount of objects that may be included within the specification. Listed below is an example of a specification. The specification is described in the examples of FIGS. 3A-3D, but may also be understood to include additional and/or different data.

```
{
“equation”: [
  {
    “variable”: “class”,
    “name”: “rr_class”,
    “outputType”: “number”,
    “transformations”: [
      {
        “min”:“−INF”,
        “minIncluded”: false,
        “max”: “INF”,
        “maxIncluded”: false,
        “slope”: 1.0,
        “intercept”: 0.0,
        “formula”: “slope*x+intercept”
      }
    ], “influencers”: [“c_age”, “c_marital-status”]
  }
],
“influencers”: [
  {
    “encodedVariable”: “c_age”,
    “variable”: “age”,
    “transformation”: “AsIs”,
    “storageType”: “integer”,
    “valueType”: “continuous”,
    “missingValue”: 0.090727440362335154,
    “missingString”: null,
    “encoding”: [
      {
        “min”:“−INF”,
        “minIncluded”: false,
        “max”: 17.0,
        “maxIncluded”: true,
        “slope”: 0.0,
        “intercept”: −0.11277775917681535,
        “formula”: “slope*x+intercept”
      },
      {
        “min”:17.0,
        “minIncluded”: false,
        “max”: 18.0,
        “maxIncluded”: true,
        “slope”: −0.001397829146008181,
        “intercept”: −0.089014663694955587,
        “formula”: “slope*x+intercept”
      },
      {
        “min”:19.0,
        “minIncluded”: true,
        “max”: 19.0,
        “maxIncluded”: true,
        “slope”: 0.0,
        “intercept”: −0.11288039362241165,
        “formula”: “slope*x+intercept”
      },
      {
        “min”:19.0,
        “minIncluded”: false,
        “max”: 21.0,
        “maxIncluded”: true,
        “slope”: −6.2620882478131579e−05,
        “intercept”: −0.11169059685534211,
        “formula”: “slope*x+intercept”
      },
      {
        “min”:22.0,
        “minIncluded”: true,
        “max”: 22.0,
        “maxIncluded”: true,
        “slope”: 0.0,
        “intercept”: −0.10885566125082458,
        “formula”: “slope*x+intercept”
      },
      {
        “min”:22.0,
        “minIncluded”: false,
        “max”: 23.0,
        “maxIncluded”: true,
        “slope”: 0.0022438518915111616,
        “intercept”: −0.15822040286372951,
        “formula”: “slope*x+intercept”
      },
      {
        “min”:24.0,
        “minIncluded”: true,
        “max”: 24.0,
        “maxIncluded”: true,
        “slope”: 0.0,
        “intercept”: −0.088762695734476593,
        “formula”: “slope*x+intercept”
      },
      {
        “min”:24.0,
        “minIncluded”: false,
        “max”: 25.0,
        “maxIncluded”: true,
        “slope”: 0.0097250209034551172,
        “intercept”: −0.32216319741588118,
        “formula”: “slope*x+intercept”
      },
      {
        “min”:26.0,
        “minIncluded”: true,
        “max”: 27.0,
        “maxIncluded”: true,
        “slope”: 0.011693056261383006,
        “intercept”: −0.37246826578438208,
        “formula”: “slope*x+intercept”
      },
      {
        “min”:28.0,
        “minIncluded”: true,
        “max”: 28.0,
        “maxIncluded”: true,
        “slope”: 0.0,
        “intercept”: −0.018403046098935061,
        “formula”: “slope*x+intercept”
      },
      {
        “min”:28.0,
        “minIncluded”: false,
        “max”: 29.0,
        “maxIncluded”: true,
        “slope”: 0.012809066214985343,
        “intercept”: −0.37705690011663884,
        “formula”: “slope*x+intercept”
      },
      {
        “min”:30.0,
        “minIncluded”: true,
        “max”: 31.0,
        “maxIncluded”: true,
        “slope”: 0.011789209870827655,
        “intercept”: −0.34699962422123359,
        “formula”: “slope*x+intercept”
      },
      {
        “min”:31.0,
        “minIncluded”: false,
        “max”: 33.0,
        “maxIncluded”: true,
        “slope”: 0.0073125381183775096,
        “intercept”: −0.20822279989358761,
        “formula”: “slope*x+30intercept”
      },
      {
        “min”:34.0,
        “minIncluded”: true,
        “max”: 35.0,
        “maxIncluded”: true,
        “slope”: 0.014983271142249621,
        “intercept”: −0.46375952717917412,
        “formula”: “slope*x+intercept”
      },
      {
        “min”:35.0,
        “minIncluded”: false,
        “max”: 36.0,
        “maxIncluded”: true,
        “slope”: 0.024466729419641786,
        “intercept”: −0.79568056688528666,
        “formula”: “slope*x+intercept”
      },
      {
        “min”:37.0,
        “minIncluded”: true,
        “max”: 39.0,
        “maxIncluded”: true,
        “slope”: 0.0020367176543885507,
        “intercept”: 0.01333216949577376,
        “formula”: “slope*x+30intercept”
      },
    ],
    “defaultValue”: 0.090727440362335154
},
{
  “encodedVariable”: “c_marital-status”,
  “variable”: “marital-status”,
  “transformation”: “AsIs”,
  “storageType”: “string”,
  “valueType”: “nominal”,
  “missingValue”: 0.21736429534190727,
  “missingString”: null,
  “encoding”: [
    {
      “categories”: [“Never-married”],
      “encodedValue”: −0.1708345192516891
    },
    {
      “categories”: [“Divorced”],
      “encodedValue”: −0.11079418032229038
    },
    {
      “categories”: [“Married-spouse-absent”, “Separated”, Widowed”],
      “encodedValue”: −0.13824813004104633
    }
  ],
  “defaultValue”: 0.21736429534190727
  }
]
}
```

Referring to FIG. 3A, the equation object 310 includes an equation of a predictive model which may be a classification model, regression model, or the like. When applying the equation to data points with the same structure as the data points used to train the model, the user can compute a predictive target value for the data points. In addition to the formula(s) to compute one or more predicted target values, other predictive indicator formulas can also be provided. Depending on a type of the model, a set of available indicators may vary. For example, the indicators may include a score which sorts data points from most likely to least likely, a probability that the data point is a target, an error bar which is associated with the score, and an odds ratio. As another example, the indicator may include an estimation indicator which estimates a target value of a data point.

In the example of FIG. 3A, the equation object 310 is a JSON equation object. The formula may be applied on data points to compute a predicted target value and other predictive indicators. The encoding of each variable may be defined by an encoding property of the related object. For each variable, a transformation may be applied on the variable and an encoding may be applied on the transformed variable. The encoding function of the variable may be defined through a set of functions (equations or mapping functions), and a specific function may be used for a specific range or set of values. For example, the function to use may be based on a value of an influencer variable as described in Table 1 below.

TABLE 1

| If the value of the influencer variable is ... | ... then |
|---|---|
| ... included in one of the specified range | ... we apply a formula on the value of the |
| values | influencer variable |
| ... included in one of the specific set of values | ... we retrieve the specific encoded value |
| | associated to the set |
| ... missing | ... we retrieve the value of the missing value |
| | property |
| ... not included in any of these cases | ... we retrieve the value of the default value |
| | property |

The influencers of the equation object may contain a lists of variables taken into account in the equation. For example, the influencers can be encoded variables which are defined in the influencers property, predictive indicators defined in the equation property, or the like. The equation input variable may be the sum of all the variables.

Referring to FIG. 3B, the predictive indicator object 320 is an indicator which relates to a target. It may be computed by a predictive model. The predictive indicator object 320 may contain information related to the predictive indicator, especially the way to compute it using influencer variables. The predictive indicator object may include different properties such as variables, names, output types, transformations, and influencers. The properties may have descriptions, types, and an indicator of whether the property is mandatory or not mandatory.

Referring to FIG. 3C, the transformation object 330 represents a formula to apply for a specific range of values. The transformation object may include various properties such as minimum, maximum, indicators of whether the lower bound and the upper bound are included in the range, a slope value to use, an intercept value to use, and a formula to apply. The properties may include descriptions, types, and an indication of whether the property is mandatory.

Referring to FIG. 3D, the influencer object 340 represents an influencer variable. The influencer object 340 includes a name of the encoded version of the influencer variable, a name of the original variable, a transformation to apply to the original variable to get the influencer variable, a storage type of the variable (integer, number, string, data, datetime, etc.), a value type of the variable (nominal, ordinal, continuous, etc.), and a definition of the encoding of the influencer variable. The properties may include descriptions, types, and an indication of whether the property is mandatory.

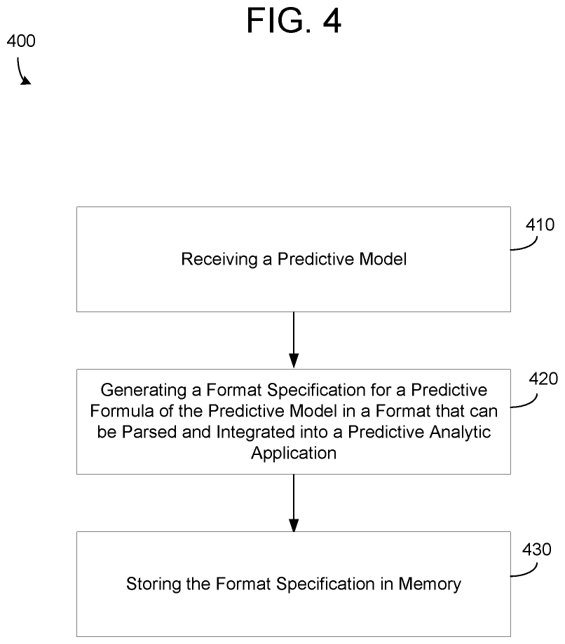

FIG. 4 illustrates a method 400 for generating a specification for a predictive model in accordance with an example embodiment. As an example, the method 400 may be performed by a database node included within a distributed database system. As another example, the method 400 may be performed by a computing device such as a server, a cloud platform, a computer, a user device, and the like. In some examples, the method 400 may be performed by a plurality of devices in combination. Referring to FIG. 4, in 410, the method may include receiving a predictive model developed via a test environment. The predictive model may include one or more formulas therein to be used by predictive analytics (e.g., classification, regression, etc.).

In 420, the method may include generating a specification for the predictive model, the specification comprising a description of a predictive formula of the predictive model in a format that is configured to be parsed and integrated into a predictive analytic. For example, the specification may be in a JSON format that is capable of being parsed and exported or otherwise integrated into a predictive analytic application regardless of a programming language used to develop the predictive analytic application. The formula may be a trained formula that performs a type of prediction such as a classification or a regression.

In some embodiments, the format specification may further include information describing internal transformations that are applied on input variables of the predictive formula to generate additional variables of the predictive formula. In some embodiments, the format specification may include a description of a plurality of predictive formulas corresponding to a plurality of steps of the predictive model. In some embodiments, the format specification may include encoding information of variables of the predictive formula. In some embodiments, the generating at 420 may include exporting the predictive formula from the predictive model to the format of the specification.

In 430, the method may include storing the generated specification in memory. The specification may be stored in association with the predictive model, or in place of the predictive model and may be exported into a live environment where it can be parsed and the predictive model can be integrated into a predictive analytics application. In some embodiments, the method may further include the parsing and the integrating of the specification.

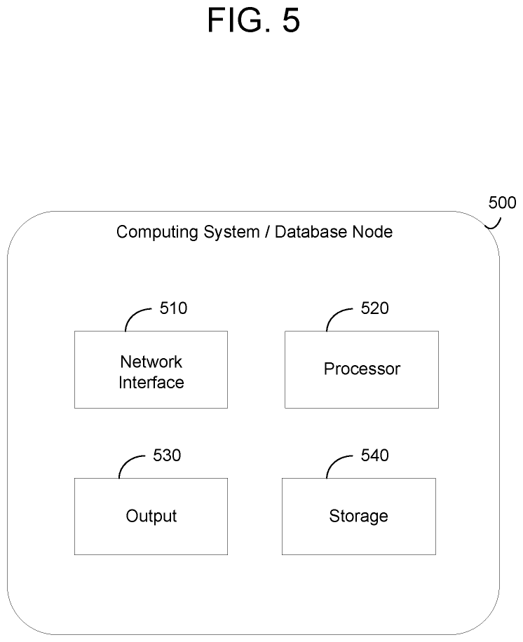

FIG. 5 illustrates a computing system 500 in accordance with an example embodiment. For example, the computing system 500 may be a database node, a server, a cloud platform, a user device, or the like. In some embodiments, the computing system 500 may be distributed across multiple devices. Referring to FIG. 5, the computing system 500 includes a network interface 510, a processor 520, an output 530, and a storage device 540 such as an in-memory storage (e.g., RAM, etc.) Although not shown in FIG. 5, the computing system 500 may also include or be electronically connected to other components such as a display, an input unit, a receiver, a transmitter, a persistent disk, and the like. The processor 520 may control the other components of the computing system 500.

The network interface 510 may transmit and receive data over a network such as the Internet, a private network, a public network, an enterprise network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like. For example, the output 530 may include a port, an interface, a cable, a wire, a board, and/or the like, with input/output capabilities. The network interface 510, the output 530, or a combination thereof, may interact with applications executing on other devices. The storage device 540 is not limited to a particular storage device and may include any known memory device such as RAM, NRAM, ROM, hard disk, and the like, and may or may not be included within the cloud environment. The storage 540 may store software modules or other instructions which can be executed by the processor 520 to perform the method 400 shown in FIG. 4.

According to various embodiments, the processor 520 may receive a predictive model developed via a test environment, and generate a specification describing the predictive model. According to various embodiments, the specification may include a description of the predictive model in a generic format that is configured to be parsed and integrated into a predictive analytics application. Furthermore, the storage device 540 (e.g., memory, etc.) may store the generated specification. For example, the predictive model may include one of a regression formula and a classification formula which is described in a generic format within the specification. In some embodiments, the specification may conform to JSON format.

In some embodiments, the specification may further include information about internal transformations that are applied on variables of the predictive model. In some embodiments, the specification may include a plurality of formulas corresponding to the predictive model. In some embodiments, the specification may further include encoding information of variables of the predictive model. In some embodiments, the processor 520 may export the predictive model to the format of the specification. In some embodiments, the processor 520 may further parse the specification to integrate the predictive model within a predictive analytics application.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a processor configured to
receive a predictive model developed via a test environment, and
generate a specification for the predictive model, the specification comprising a description of the predictive model in a format that is configured to be parsed and integrated into a predictive analytics application; and
a memory configured to store the generated specification.

2. The computing system of claim 1, wherein the predictive model comprises one of a regression formula and a classification formula.

3. The computing system of claim 1, wherein the specification comprises a JavaScript Object Notation (JSON) specification.

4. The computing system of claim 1, wherein the specification further comprises information about internal transformations that are applied on variables of the predictive model.

5. The computing system of claim 1, wherein the specification comprises a plurality of formulas of the predictive model.

6. The computing system of claim 1, wherein the specification further comprises encoding information of variables of the predictive model.

7. The computing system of claim 1, wherein the processor is configured to export the predictive model to the format of the specification.

8. The computing system of claim 1, wherein the processor is further configured to parse the specification to integrate the predictive model within the predictive analytics application.

9. A method comprising:
receiving a predictive model developed via a test environment;
generating a specification for the predictive model, the specification comprising a description of the predictive model in a format that is configured to be parsed and integrated into a predictive analytics application; and
storing the generated specification in memory.

10. The method of claim 9, wherein the predictive model comprises one of a regression formula and a classification formula.

11. The method of claim 9, wherein the specification comprises a JavaScript Object Notation (JSON) specification.

12. The method of claim 9, wherein the specification further describes internal transformations that are applied on variables of the predictive model.

13. The method of claim 9, wherein the specification comprises a plurality of predictive formulas of the predictive model.

14. The method of claim 9, wherein the specification further comprises encoding information of variables of the predictive model.

15. The method of claim 9, wherein the generating comprises exporting the predictive model to the format of the specification.

16. The method of claim 9, wherein the processor is further configured to parse the specification to integrate the predictive formula within the predictive analytics application.

17. A non-transitory computer-readable storage medium storing program instructions that when executed cause a processor to perform a method comprising:
receiving a predictive model developed via a test environment;
generating a specification for the predictive model, the specification comprising a description of the predictive model in a format that is configured to be parsed and integrated into a predictive analytics application; and
storing the generated specification in memory.

18. The non-transitory computer readable medium of claim 17, wherein the predictive model comprises one of a regression formula and a classification formula.

19. The non-transitory computer readable medium of claim 17, wherein the specification comprises a JavaScript Object Notation (JSON) specification.

20. The non-transitory computer readable medium of claim 17, wherein the specification further comprises information about internal transformations that are applied on variables of the predictive model.
